(19) United States
(12) Patent Application Publication
(10) Pub. No.: US 2024/0029561 A1
(43) Pub. Date: Jan. 25, 2024

(54) SERVER DEVICE AND CONTROLLING METHOD FOR A SERVER DEVICE

(71) Applicants: HYUNDAI MOTOR COMPANY, Seoul (KR); KIA CORPORATION, Seoul (KR)

(72) Inventor: Hyun Mok Kim, Seoul (KR)

(73) Assignees: HYUNDAI MOTOR COMPANY, Seoul (KR); KIA CORPORATION, Seoul (KR)

(21) Appl. No.: 18/208,407

(22) Filed: Jun. 12, 2023

(30) Foreign Application Priority Data
Jul. 20, 2022 (KR) 10-2022-0089273

(51) Int. Cl. G08G 1/0968; H04L 67/12

(52) U.S. Cl. CPC G08G 1/096811; H04L 67/12

(57) ABSTRACT

Provided are a sever device and a controlling method of the server device. The server device includes a communication unit communicating with a plurality of vehicles belonging to a pre-set group, and a controller configured to control the communication unit to, during group driving in which the plurality of vehicles travel to a first destination, when a first vehicle from among the plurality of vehicles reaches the first destination, receive a response signal regarding whether to reset the first destination from the first vehicle, and transmit a reset destination to a second vehicle among the plurality of vehicles.

### CROSS-REFERENCE TO RELATED APPLICATION

This application claims priority to Korean Patent Application No. 10-2022-0089273, filed on Jul. 20, 2022, and all the benefits accruing therefrom under 35 U.S.C. § 119, the contents of which in its entirety are herein incorporated by reference.

### BACKGROUND

### 1. Field

The disclosure relates to a server device for dealing with a situation that may occur during group driving, and a controlling method of the server device.

### 2. Description of the Related Art

Group driving refers to a technology in which a plurality of vehicles belong to a group to travel to the same first destination.

In group driving, when a plurality of vehicles move in a group, location information between the vehicles may be exchanged and a driving route may be tracked and displayed through a server.

When a change occurs in a first destination among the vehicles of the group, a technology for resetting a first destination is required.

### SUMMARY

According to an aspect of the disclosure, there is provided a server device capable of resetting a first destination when a vehicle of a group reaches a first destination first during group driving and thus a change occurs in the first destination, and a controlling method of the server device.

A server device according to an embodiment includes: a communication unit communicating with a plurality of vehicles belonging to a pre-set group: and a controller configured to control the communication unit. In particular, during group driving in which the plurality of vehicles travel to a same destination (i.e., an initial destination), when a first vehicle from among the plurality of vehicles reaches the initial destination, receive a response signal regarding whether to reset the initial destination from the first vehicle, and transmit a reset destination to a second vehicle among the plurality of vehicles.

The controller may be configured to, when the first vehicle is not a vehicle that sets the initial destination of the group driving, give an authority to reset the initial destination to the first vehicle.

The controller may be configured to control the communication unit to, when an acceptance signal is received as the response signal regarding whether to reset the initial destination from the first vehicle, transmit the reset destination and a resetting message to the second vehicle.

The controller may be configured to control the communication unit to, when an acceptance signal is received as the response signal regarding whether to reset the initial destination, transmit a route to the reset destination to the second vehicle.

The controller may be configured to, when a rejection signal is received as the response signal regarding whether to reset the initial destination from the first vehicle, designate, as a new first vehicle, a vehicle reaching the initial destination right after the first vehicle among the plurality of vehicles.

The server device may further include a memory.

The controller may be configured to control the communication unit to receive a resetting message selected from among a plurality of resetting messages stored in the memory from a driver of the first vehicle and transmit the selected resetting message to the second vehicle.

The controller may be configured to control the memory to store the reset destination in the memory.

According to an embodiment of the present disclosure, a controlling method of a server device includes: during group driving in which a plurality of vehicles travel to a first destination, when a first vehicle from among the plurality of vehicles reaches the first destination, receiving from the first vehicle a response signal regarding whether to reset a first destination to a second destination; and transmitting the second destination to a second vehicle among the plurality of vehicles.

The controlling method may further include, when the first vehicle is not a vehicle that sets the first destination of the group driving, giving authority to reset the first destination to the first vehicle.

The transmitting of the second destination may include, when an acceptance signal is received as the response signal regarding whether to reset the first destination from the first vehicle, transmitting the second destination and a resetting message to the second vehicle.

The controlling method may further include, when an acceptance signal is received as the response signal regarding whether to reset the first destination, transmitting a route to the second destination to the second vehicle.

The controlling method may further include, when a rejection signal is received as the response signal regarding whether to reset the first destination from the first vehicle, changing a vehicle reaching the first destination right after the first vehicle to a new first vehicle.

The transmitting of the resetting message to the second vehicle may include: receiving a resetting message selected among a plurality of resetting messages stored in a memory from a driver of the first vehicle; and transmitting the selected resetting message to the second vehicle.

The controlling method may further include controlling a memory to store the reset destination (i.e., the second destination) in the memory.

### BRIEF DESCRIPTION OF THE DRAWINGS

In order that the disclosure may be well understood, there is now described various forms thereof, given by way of example, reference being made to the accompanying drawings, in which:

FIG. 1 is a control block diagram of a server device, according to an embodiment;

FIG. 2 is a view illustrating an example where a server device and a plurality of vehicles communicate with each other, according to an embodiment;

FIG. 3 is a view illustrating that one of vehicles of a group reaches a first destination first in a server device, according to an embodiment;

FIG. 4 is a view illustrating that a server device communicates with a first vehicle and a second vehicle, according to an embodiment;

FIGS. 5A and 5B are views illustrating that a question about whether to change a destination is transmitted to a first vehicle in a server device, according to an embodiment;

FIG. 6 is a view illustrating that a server device receives an acceptance signal for a destination changing proposal from a first vehicle and questions a second vehicle about whether to change a destination, according to an embodiment;

FIG. 7 is a view illustrating that a changed route is displayed on an output unit of a second vehicle in a server device, according to an embodiment;

FIG. 8 is a control flowchart of a first vehicle that reaches a destination first in a server device, according to an embodiment;

FIG. 9 is a control flowchart of a group member vehicle other than a first vehicle in a server device, according to an embodiment; and

FIG. 10 is a main flowchart of a server device, according to an embodiment.

### DETAILED DESCRIPTION

The description proposed herein is just an example for the purpose of illustrations only and not intended to limit the scope of the disclosure. It should be understood that other equivalents and modifications could be made thereto without departing from the scope of the disclosure.

Like reference numerals or signs in the drawings of the specification denote like components or elements that perform substantially the same functions.

The terms used in the present specification are merely used to describe embodiments and are not intended to limit and/or restrict the disclosure. The singular forms “a,” “an,” and “the” are intended to include the plural forms as well, unless the context clearly indicates otherwise. Further, as used in this specification, the terms “include,” “have” and their conjugates may be construed to denote a feature, number, step, operation, constituent element, component, or a combination thereof, but may not be construed to exclude the existence or addition of one or more other features, numbers, steps, operations, constituent elements, components, or combinations thereof.

It should be understood that although the terms “first,” “second,” and the like, may be used herein to describe various elements. These elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

Also, the terms such as “unit”, “. . . er”, “block”, “member”, or “module” may refer to a unit for processing at least one function or operation. For example, the above term may refer to at least one process processed by at least one hardware such as a field-programmable gate array (FPGA)/application-specific integrated circuit (ASIC), or at least one software stored in a memory 30, or a processor.

Reference numerals used in operations are used to identify the operations, without describing the order of the operations, and the operations may be performed in an order different from the stated order unless a specific order is definitely specified in the context.

Disclosed embodiments may be implemented on a recording medium storing instructions executable by a computer. The Instructions may be stored as program code, and when being executed by a processor, may perform operations of the disclosed embodiments. The recording medium may be implemented as a computer-readable recording medium.

The computer-readable recording medium includes any type of recording medium in which instructions readable by a computer are stored. Examples of the computer-readable recording medium may include a read-only memory (ROM), a random-access memory (RAM), a magnetic tape, a magnetic disk, a flash memory 30, and an optical data storage device.

When a component, device, element, or the like of the present disclosure is described as having a purpose or performing an operation, function, or the like, the component, device, or element should be considered herein as being “configured to” meet that purpose or to perform that operation or function.

A vehicle 1 and a control method of the vehicle 1 according to an aspect are now described in detail with reference to the accompanying drawings.

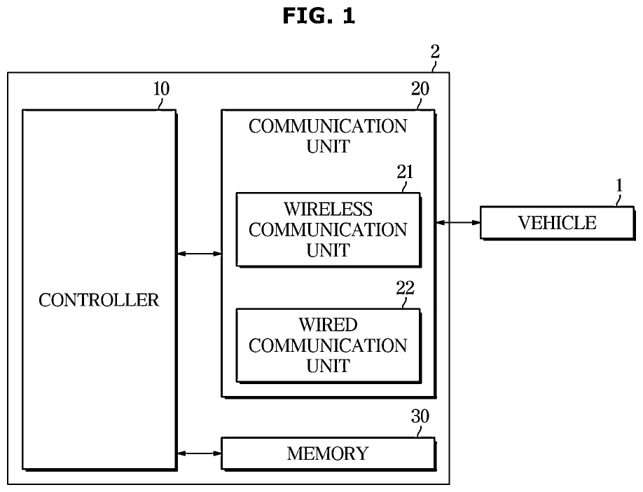

FIG. 1 is a control block diagram of a server device, according to an embodiment.

Referring to FIG. 1, a server device 2 includes a communication unit a memory 30, and a controller 10.

The communication unit 20 may communicate with a vehicle 1 of a group through a wireless communication base station, and various communication methods may be applied.

The communication unit 20 may use, as a communication method, a second generation (2G) communication method such as time-division multiple access (TDMA) or code-division multiple access (CDMA), a third generation (3G) communication method such as wide code-division multiple access (WCDMA), code-division multiple access 2000 (CDMA2000), wireless broadband (Wibro), or world interoperability for microwave access (WiMAX), or a fourth generation (4G) communication method such as long-term evolution (LTE) or wireless broadband evolution. The communication unit 20 may use a fifth generation (5G) communication method.

The communication unit 20 may include one or more elements for communication with an external device. For example, the communication unit may include at least one of a short-range communication module, a wired communication unit 22, and a wireless communication unit 21.

The short-range communication module may include any of various short-range communication modules for transmitting and receiving a signal by using a wireless communication network in a short distance such as a Bluetooth™ module, an infrared communication module, a radio-frequency identification (RFID) communication module, a wireless local access network (WLAN) module, a near-field communication (NFC) communication module, or a Zigbee™ communication module.

The wired communication unit 22 may include any of various cable communication modules such as universal serial bus (USB), high-definition multimedia interface (HDMI), digital visual interface (DVI), recommended standard 232 (RS-232), power line communication, or plain old telephone service (POTS) as well as any of various wired communication units 22 such as a controller area network (CAN) communication module, a local area network (LAN) module, a wide area network (WAN) module, or a value-added network (VAN) module.

The wireless communication unit 21 may include a wireless communication unit 21 supporting any of various wireless communication methods such as global system for mobile communication (GSM), code-division multiple access (CDMA), wideband code-division multiple access (WCDMA), universal mobile telecommunications system (UMTS), time-division multiple access (TDMA), or long-term evolution (LTE) as well as a radio data system-traffic message channel (RDS-TMC), digital multimedia broadcasting (DMB), a Wi-Fi™ module, or a wireless broadband module.

The wireless communication unit 21 may include a wireless communication interface including an antenna and a receiver for receiving a response regarding whether to reset a first destination from the vehicle 1. Also, the wireless communication unit 21 may further include a signal conversion module for demodulating an analog wireless signal received through the wireless communication interface into a digital control signal.

When road information such as closed-circuit television (CCTV) information of a road, speed camera data, sensor data of autonomous vehicles 1, or data of surrounding vehicles 1 is collected, the communication unit 20 may receive the collected road information from an external device (not shown).

The communication unit 20 may transmit a signal regarding whether to reset a first destination to a first vehicle 1-5 belonging to one group. The communication unit 20 may also transmit a reset destination (e.g., a second destination) to second vehicles 1 that are the remaining vehicles 1 other than the first vehicle 1-5 in the group.

The memory 30 may include a volatile memory 30 such as a static random-access memory (S-RAM) or a dynamic random-access memory (D-RAM), and a non-volatile memory 30 such as a read-only memory (ROM) or an erasable programmable read-only memory (EPROM). The memory 30 may include one memory device or may include a plurality of memory devices.

The memory 30 may store common first destination information of group driving. The memory 30 may also store driver information and location information of the vehicle 1 of the group.

When the first vehicle 1-5 included in a plurality of vehicles 1 during group driving reaches a first destination first, the controller 10 may control the communication unit 20 to transmit a signal regarding whether to reset the first destination to the first vehicle 1-5.

The term ‘group driving’ may refer to a technology in which a plurality of vehicles 1 belong to one group to travel to the same first destination.

In detail, the server device 2 according to an embodiment may set a plurality of vehicles 1 to be driven to the same first destination as one driving group.

The server device 2 may receive a request for group creation from a leader vehicle 1-1 that is one of the plurality of vehicles 1.

The controller 10 may receive, through the communication unit 20, a request for invitation and deletion of group member vehicles 1 to 1-n corresponding to group members from the leader vehicle 1-1.

The leader vehicle 1-1 that is a driver creating the group may have the authority to set a destination for the group.

The server device 2 may receive, through the communication unit 20, current location information of all of the vehicles 1 including the leader vehicle 1-1 and the group member vehicles 1 to 1-n and collected road traffic conditions.

The controller 10 may receive global positioning system (GPS) information to calculate locations of all of the vehicles 1 in the group, a route to a destination, and a driving route.

In order to calculate a driving route, the controller 10 may use a navigation system that is a road and traffic information providing system for guiding an optimal route in consideration of traffic conditions and a distance from a current location to a destination.

The navigation system may include: a receiver (GPS antenna) for receiving radio waves of a satellite navigation system in the server device 2 to calculate a current location; an electronic map for providing road and route information: software for calculating and guiding an optimal route in consideration of road and traffic conditions: and a storage device in the server device 2.

The controller 10 may control the communication unit 20 to transmit information such as a location and a driving route of each of the leader vehicle 1-1 and the group member vehicles 1 to 1-n to all of the vehicles 1.

All of the vehicles 1 belonging to one group may share their location information.

A method by which each vehicle 1 shares location information may be vehicle-to-vehicle (V2V) communication.

V2V communication may refer to communication between the vehicles 1, and each vehicle 1 may transmit and receive data through unique wireless communication. V2V communication may use all types of wireless components so that the vehicles 1 communicate with each other. V@V communication may also create a vehicle ad hoc network (VANET).

There is a limitation on a method by which each vehicle 1 shares location information.

The vehicle 1 may include a user interface (not shown). The user interface may include an input unit 41 and an output unit 42.

The input unit 41 may refer to a device using which a driver inputs a response regarding whether to reset a destination or selects a plurality of resetting messages. The output unit 42 may refer to a device for displaying a reset destination and route.

The user interface may include an audio video navigation (AVN) display. In this embodiment, the input unit 41 for receiving a user's command and the output unit 42 for displaying a reset destination and route are not necessarily limited to the AVN display.

In the user interface, even when the input unit 41 is not an AVN display, any input unit 41 may be used as long as a driver in the vehicle 1 may input a command, and even when the output unit 42 is not an AVN display, any output unit 42 may be used as long as display content may be identified.

For example, the input unit 41 may be an automotive voice recognition system, and the output unit 42 may be a speaker in the vehicle 1 which outputs sound.

When the user utters instructions, the automotive voice recognition system may: analyze the input instructions; determine a domain corresponding to the instructions; and perform an operation.

When the input unit 41 is the automotive voice recognition system, the user may accept or reject whether to reset a destination by voice, or may identify joining information of another group vehicle 1 by voice.

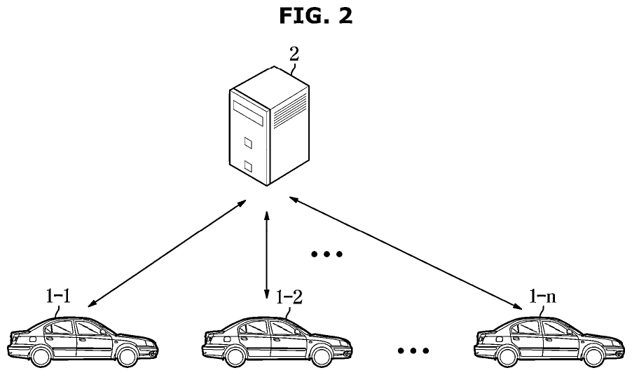

FIG. 2 is a view illustrating an example where a server device and a plurality of vehicles communicate with each other, according to an embodiment.

Referring to FIG. 2, the server device 2 according to an embodiment may determine a plurality of vehicles 1-1, 1-2, . . . , and 1-n as one group. The server device 2 may identify a first vehicle 1-5 that reaches a destination first among the plurality of vehicles 1-1, 1-2, . . . , and 1-n based on the first vehicle 1-5. The server device 2 may determine the remaining vehicles 1 other than the first vehicle 1-5 as second vehicles 1.

The server device 2 may perform wireless communication with the plurality of vehicles 1-1, 1-2, . . . , and 1-n through a network. The wireless communication may be a well-known communication method.

Examples of the vehicle 1 according to an embodiment may include a vehicle 1 using an internal combustion engine, a vehicle 1 using electric power, an electric wheel, an electric kickboard, an electric bicycle, and a micro electric vehicle. A type of the vehicle 1 is not limited thereto, and any type of vehicle 1 may be used as long as the vehicle 1 may communicate with the server device 2.

The server device 2 according to an embodiment may perform wireless communication with the plurality of vehicles 1-1, 1-2, . . . , and 1-n through a network, and a first vehicle 1-4 from among the plurality of vehicles 1-1 , 1-2, . . . , and 1-n may transmit a reset destination to the server device 2 and second vehicles 1-1, 1-2, and 1-3 may receive the reset destination.

A network (not shown) according to an embodiment may support communication between the server device 2 and the plurality of vehicles 1-1, 1-2, . . . , and 1-n, and may be at least one of a telecommunications network, for example, a computer network (e.g., LAN or WAN), the Internet, or a telephone network. As described above, a type of the network is not limited thereto, and any type of network may be used as long as the network supports communication.

As shown in FIG. 2, the server device 2 may determine the number of vehicles 1-1, 1-2, . . . , and 1-n included one group from 2 to n, and may set a leader vehicle 1-1 to the plurality of vehicles 1-1, 1-2, . . . , and 1-n.

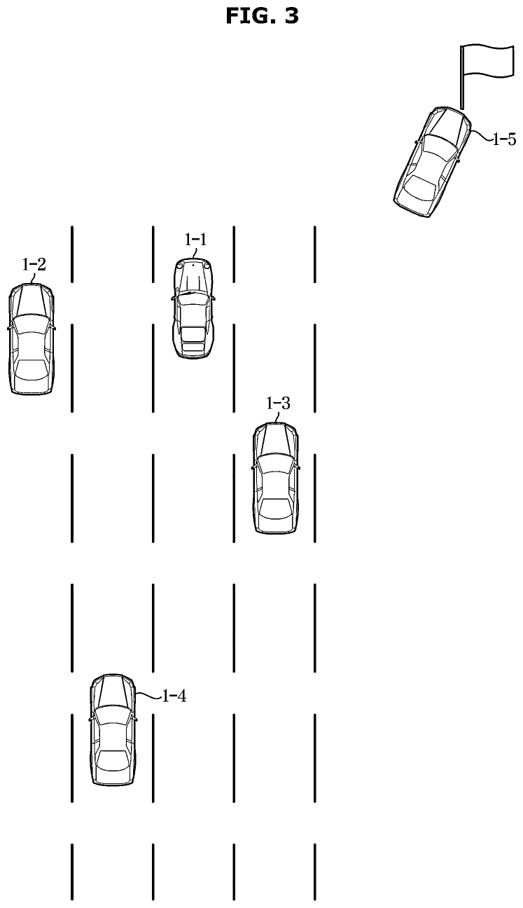

FIG. 3 is a view illustrating that one of vehicles of a group reaches a destination first in a server device, according to an embodiment.

Referring to FIG. 3, a first vehicle 1-5 that is a group member vehicle 1 among a plurality of vehicles 1-1, 1-2, . . . , and 1-n may reach an initial destination before a leader vehicle 1, and the initial destination may be subject to change, thereby making it difficult to achieve the original purpose.

For example, a change in a destination may refer to a case where the parking lot of the initial destination is full, the business is closed, or the initial destination is relocated to another place, and thus, the initial destination is unsuitable as a destination for the group driving.

When a change occurs in a destination, in the prior art, a destination should be changed after all of the vehicles 1 in the group reach the initial destination, or an additional communication means such as a smartphone should be used to change a destination.

In the prior art, a time required for all of vehicles in a group to reach a final destination may be wasted, and it may be difficult to concentrate on driving because of an additional communication means.

In order to solve these problems, when the first vehicle 1-5, which is one of the plurality of vehicles 1 during group driving, reaches an initial destination first, the server device 2 according to an embodiment may question the first vehicle 1-5 about whether to reset a destination.

The server device 2 may receive, from the first vehicle 1-5, a response signal regarding whether to reset the initial destination to a new destination (hereinafter, “a reset destination” or “a second destination”), and may transmit the reset destination or a route to second vehicles (i.e., vehicles 1-1, 1-2, 1-3, and 1 -4) other than the first vehicle 1 among the plurality of vehicles 1.

According to the server device 2 of an embodiment, a time required for all of vehicles in a group to reach a final destination may be saved and it may be possible to concentrate on driving because an additional communication means is not used, thereby improving safety.

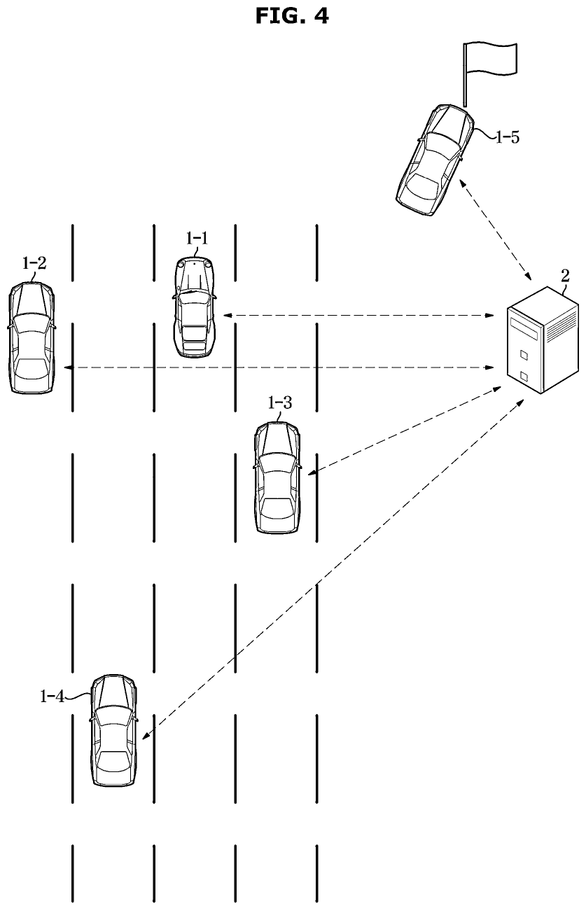

FIG. 4 is a view illustrating that a server device communicates with a first vehicle and a second vehicle, according to an embodiment.

Referring to FIG. 4, the server device 2 may communicate with a first vehicle 1-5 that reaches an initial destination first, and the server device 2 may communicate with second vehicles 1-1, 1-2, 1-3, and 1-4 that are the remaining vehicles other than the first vehicle 1-5.

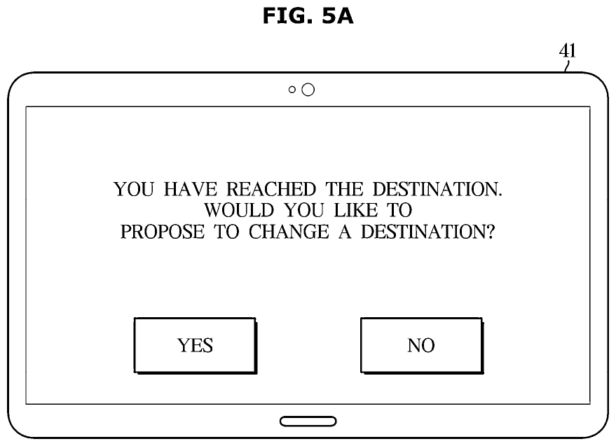

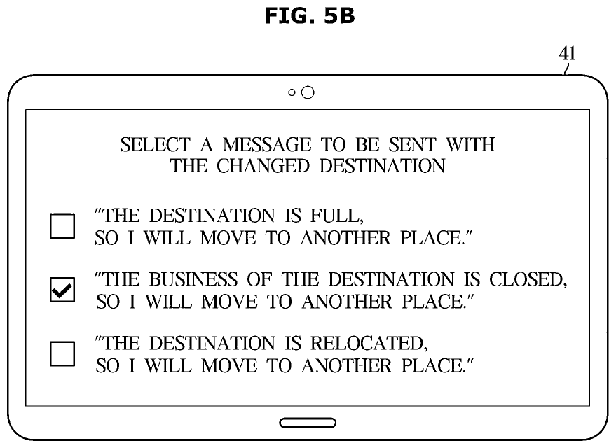

The controller 10 may transmit a signal for identifying whether to reset the initial destination to the first vehicle 1-5 that reaches first at the initial destination. When a change occurs in the initial destination, as described below with reference to FIG. 5A, the controller 10 may receive, from the first vehicle 1-5, a response signal regarding whether to reset the initial destination.

When the controller 10 receives an acceptance signal as the response signal regarding whether to reset the initial destination from the first vehicle 1-5, the controller 10 may receive a reset destination and a resetting message input by a driver of the first vehicle 1-5.

When the controller 10 receives the acceptance signal from the first vehicle 1-5, the controller 10 may: determine that a change occurs in the initial destination; receive a reset destination and a resetting message from the first vehicle 1-5; and transmit the reset destination and the resetting message to each of the second vehicles.

The second vehicles may identify the reset destination without using a separate communication means such as a smartphone, and a route may be changed without a driver's intervention, thereby improving safety.

The controller 10 may control the memory 30 to store the reset destination in the memory 30. The controller 10 may also update the memory whenever a destination (e.g., the initial destination) is reset.

A method by which the second vehicle 1 changes a route may be a method by which the server device 2 selects a reset route transmitted to the second vehicle 1, or a method by which the server device 2 transmits a destination (e.g., a reset destination) and a navigation system of the second vehicle 1 changes a route to the reset destination.

When the first vehicle 1-5 that reaches the initial destination first is not a vehicle 1 that sets the initial destination of group driving, the controller 10 may give the authority to reset a destination to the first vehicle 1-5.

As described above, the controller 10 may give the authority to set and change a destination (e.g., the initial destination) only to a leader vehicle 1 in the group driving, and may not give the authority to set and change a destination to any other vehicle in the group member vehicles 1.

Because the leader vehicle 1 has the authority to change a destination as well as the authority to set the initial destination, when the leader vehicle 1 is the first vehicle 1-5 that first reaches at the initial destination, it is not necessary to give the authority to reset a destination to the first vehicle 1-5.

When the first vehicle 1-5 is the leader vehicle 1 that sets the initial destination of the group driving, the first vehicle 1-5 already has the authority to reset a destination, and thus, the controller 10 may give the authority to reset a destination only when the first vehicle 1-5 is not the leader vehicle 1.

The server device 2 may receive, through the communication unit 20, current location information of all of the vehicles 1 including the leader vehicle 1-1 and the group member vehicles 1-1, 1-2, 1-3, 1-4, and 1-5 and collected road traffic conditions.

The server device 2 may identify current locations of all of the vehicles 1 constituting one group in real time.

The controller 10 may calculate a distance a newly set destination (i.e., a reset destination) and each of the second vehicles 1-1, 1-2, 1-3 and 1-4. The controller 10 may store the distance between each of the second vehicles and the newly set destination in the memory 30.

FIGS. 5A and 5B are views illustrating that a question about whether to change a destination is transmitted to a first vehicle in a server device, according to an embodiment.

FIG. 5A illustrates the input unit 41 of a first vehicle 1-5. Referring to FIG, 5A, as described above, the input unit 41 of the first vehicle 1-5 may include an audio video navigation (AVN) display but is not limited thereto and may include an automotive voice recognition system.

Referring to FIG. 5A, the input unit 41 of the first vehicle may include an AVN display. A driver of the first vehicle 1-5 that reaches a destination first may select ‘Yes’ or ‘No’ with respect to a destination resetting signal.

In response, the driver of the first vehicle 1-5 may transmit an acceptance signal or a rejection signal for the destination resetting signal to the server device 2.

Alternatively, when the input unit 41 of the first vehicle 1 is an automotive voice recognition system, the driver of the first vehicle 1-5 may utter instructions for voice recognition to determine whether to accept a destination resetting proposal.

FIG. 5B illustrates the input unit 41 of the first vehicle 1-5 as shown in FIG. 5A. Referring to FIG. 5B, the controller 10 may transmit a destination resetting message stored in the memory 30 to the first vehicle 1-5 in response to the acceptance of the destination resetting proposal by the driver of the first vehicle 1-5.

The destination resetting message may be stored in the memory 30 of the vehicle 1, and may be loaded from the memory 30 of the vehicle 1 when the driver of the first vehicle 1-5 transmits an acceptance signal for the destination resetting proposal to the server device 2.

The driver of the first vehicle 1-5 may input a reset destination. The driver of the first vehicle 1-5 may also select a resetting message to be transmitted to the second vehicles.

The driver of the first vehicle 1-5 may input the reset destination and may select the resetting message to be performed first.

The driver of the first vehicle 1-5 may select a resetting message to notify a reason for resetting a destination (e.g., the initial destination) to the second vehicle 1 while resetting a destination.

The resetting message may include a reason or purpose for resetting a destination.

For example, the resetting message may include a message such as “the parking lot of the initial destination is full, so I will move to another place”, “the business of the initial destination is closed, so I will move to another place”, or “the initial destination is relocated, so I will move to another place”.

When the driver of the first vehicle 1-5 selects a destination resetting message based on a change in the initial destination, the controller 10 may transmit the resetting message to the second vehicle.

Accordingly, the driver of the first vehicle 1-5 does not need to notify a reason for resetting a destination to drivers of the second vehicles through a separate communication device. The driver of the first vehicle 1-5 does not need to type a message because the message is previously stored in the memory 30.

According to the server device 2 of an embodiment, a need for the driver of the first vehicle 1-5 to notify a reason for resetting a destination to the drivers of the second vehicles through a separate communication device may be reduced. A time required to contact the drivers of the second vehicles 1 may also be reduced.

Because the resetting message is displayed inside the second vehicles or is output through a speaker, a need for the driver of the second vehicles to identify the resetting message separately may be reduced.

A method by which the driver of the first vehicle 1-5 selects a destination resetting message based on a change in an initial destination is not limited and may include a method of using a dial operation unit provided in the first vehicle 1-5 or touching an AVN display.

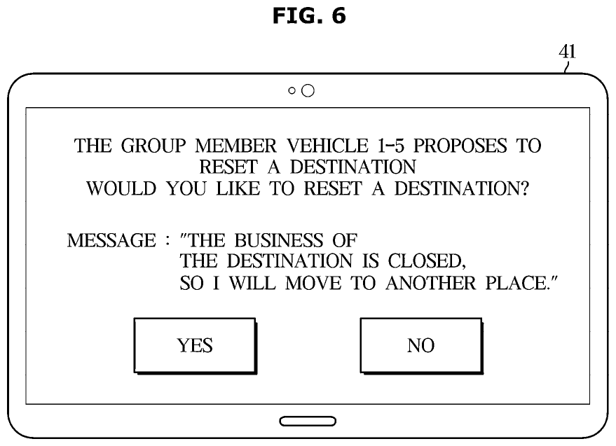

FIG. 6 is a view illustrating that a server device receives an acceptance signal for a destination changing proposal from a first vehicle and questions a second vehicle about whether to change a destination, according to an embodiment.

FIG. 6 illustrates the input unit 41 of a second vehicle 1, and the input unit 41 of the second vehicle 1 includes an AVN display.

Referring to FIG. 6, when a driver of a first vehicle 1-5 that reaches a destination first selects ‘Yes’ with respect to a destination resetting signal, the controller 10 may control the second vehicle 1 to select whether to accept a destination resetting proposal.

In other words, when a destination for the group member vehicles is reset by the server device 2 but a second vehicle among the group member vehicles should reach the initial destination due to a personal reason of a driver of the second vehicle, the controller 10 may allow the second vehicle to select whether to accept the destination resetting proposal.

The controller 10 may also output a resetting message selected in FIG. 5B.

When the controller 10 receives an acceptance signal for a destination resetting proposal from the second vehicle 1, the controller 10 may transmit a changed route to the second vehicle 1 or may transmit only a new destination to the second vehicle 1.

When the controller 10 receives a rejection signal for a destination resetting proposal from the second vehicle, the controller 10 may maintain the initial destination and the initial route to the initial destination of the second vehicle 1.

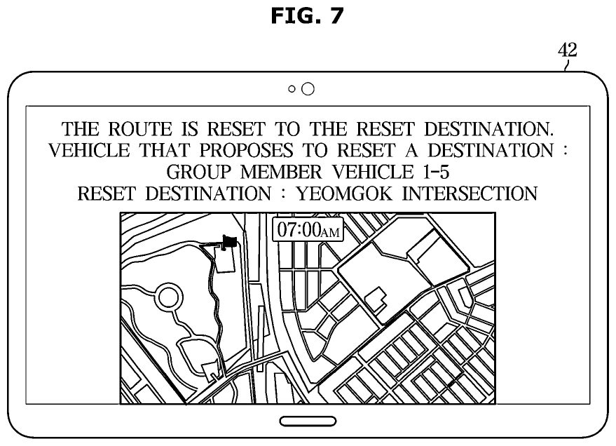

FIG. 7 is a view illustrating that a changed route is displayed on an output unit of a second vehicle in a server device, according to an embodiment.

Referring to FIG. 7, the output unit 42 may include an audio video navigation (AVN) display and may notify a changed route to a driver of a second vehicle 1.

The controller 10 may transmit a simple message such as “the route is changed to a reset destination” to the output unit 42 of each of second vehicles 1-1, 1-2, 1-3, and 1-4.

The controller 10 may transmit a message indicating that second vehicle information is a “group member vehicle 1-5” and a specific reset destination is “Yeomgok intersection”.

The controller 10 may calculate an optimal route to the second destination (e.g., the reset destination) and may transmit the calculated route to the first vehicle 1-5 as well as to the second vehicles 1-1, 1-2, 1-3, and 1-4.

The controller 10 may calculate an optimal route to the reset destination and may transmit the route even to the first vehicle 1-5 so that the first vehicle 1-5 that resets the initial destination is directly guided to the reset destination without setting a route.

The group vehicles 1 that accept a destination resetting proposal may continue group driving toward the reset destination.

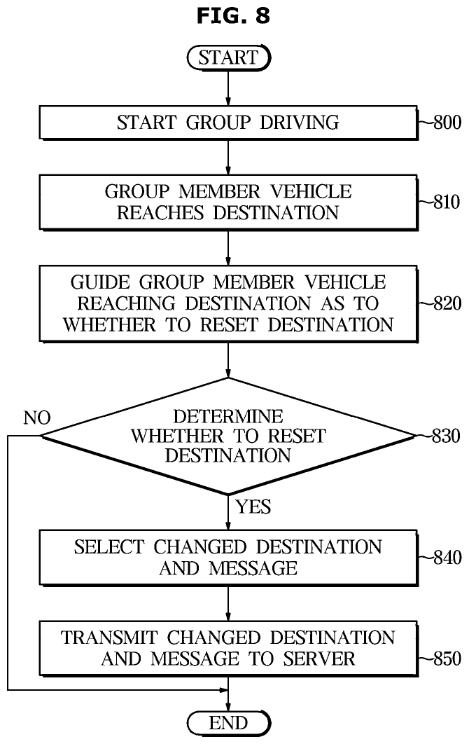

FIG. 8 is a control flowchart of a first vehicle that reaches a destination first in a server device, according to an embodiment.

From the viewpoint of a first vehicle 1-5, referring to FIG. 8, a plurality of vehicles 1 belonging to one group may start group driving (800).

The group driving may be created by a leader vehicle 1-1, and may include a plurality of group member vehicles 1-n. The group driving may have a common destination, and an initial destination as the common destination may be set by the leader vehicle 1-1.

Any one vehicle 1 from among the plurality of vehicles 1 belonging to the group may reach the initial destination before the other vehicles 1 (810). The first vehicle 1-5 that reaches the initial destination may correspond to the leader vehicle 1-1 and the group member vehicles 1-n.

The first vehicle 1-5 may be guided by a server as to whether to reset a destination (820).

Next, a driver of the first vehicle 1-5 may determine whether to reset a destination (830), and the driver of the first vehicle 1-5 may select a reset destination and a resetting message to reset a destination (840).

When the driver of the first vehicle 1-5 selects the reset destination and the resetting message, the driver of the first vehicle 1-5 may transmit the reset destination and the resetting message to the server device 2 through the communication unit 20 of the first vehicle 1-5 (850).

The server device 2 may transmit the reset destination and the resetting message to a second vehicle 1 to reset the initial destination of the group.

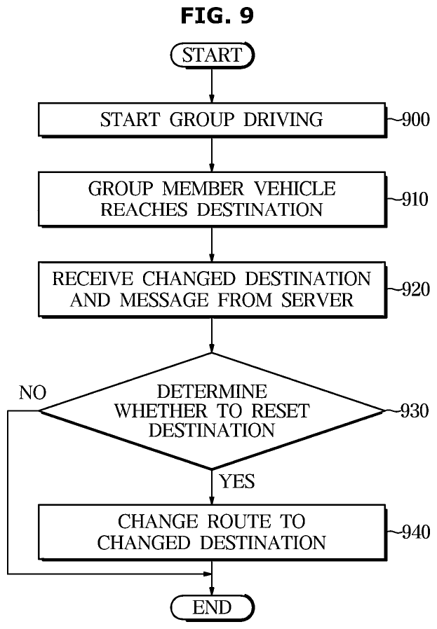

FIG. 9 is a control flowchart of a group member vehicle other than a first vehicle in a server device, according to an embodiment.

From the viewpoint of a first vehicle 1-5, referring to FIG. 9, a plurality of vehicles belonging to one group may start group driving (900).

Any one vehicle 1 from among the plurality of vehicles 1 belonging to the group may reach a destination before the other vehicles 1 (910). In this case, the first vehicle 1-5 that reaches the destination may correspond to a leader vehicle 1-1 and group member vehicles 1-n.

A second vehicle 1 corresponding to a group vehicle 1 other than the first vehicle 1-5 may receive a reset destination and a resetting message from the server device 2 (920).

Next, a driver of the second vehicle 1 may determine whether to reset a destination (930), and the controller 10 of the server device 2 may change a route of the second vehicle 1 to a route toward a changed destination (940).

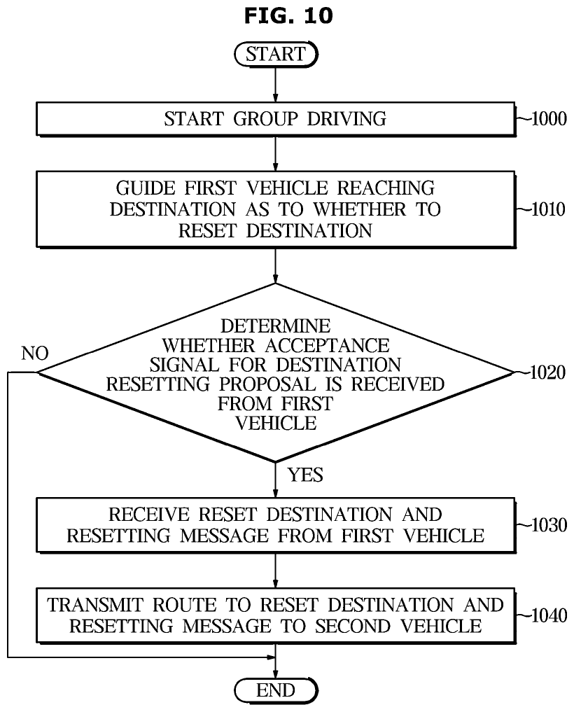

FIG. 10 is a main flowchart of a server device, according to an embodiment.

A controlling method of the server device 2 is described with reference to FIG. 10.

A plurality of vehicles 1 belonging to one group may start group driving (1000).

The controller 10 of the server device 2 may guide a first vehicle 1-5, which reaches a destination first, as to whether to reset a destination (1010).

The controller 10 may transmit a signal to the output unit 42 of the first vehicle 1-5 to display a message regarding a destination resetting proposal.

Next, the controller 10 may receive an acceptance signal for the destination resetting proposal from the first vehicle 1-5 (yes in 1020).

When the controller 10 receives the acceptance message for the destination resetting proposal from the first vehicle 1-5, the controller 10 may determine that a driver of the first vehicle 1-5 intends to change the destination due to a change in the destination.

The controller 10 may receive a reset destination and a selected resetting message from the first vehicle 1-5.

The controller 10 may transmit the reset destination and the selected resetting message received from the first vehicle 1-5 to a second vehicle, to change its destination to the reset destination for the second vehicle.

The second vehicle may determine whether to change its destination, and a destination of a group member vehicle accepting the destination changing proposal may be changed to the reset destination.

According to the server device 2 of an embodiment, because the controller 10 collectively changes a destination of the second vehicle according to a destination resetting proposal of the first vehicle 1-5, when a change occurs in a destination during group driving, this may be rapidly dealt with, and an operation for changing a route of the remaining group member vehicles 1 may be minimized, thereby improving safety.

A server device and a controlling method of the server device according to an aspect of the disclosure may, when a change occurs in a destination during group driving, rapidly deal with the change, and may minimize an operation for changing a route of the remaining group member vehicles, thereby improving safety.

The disclosed embodiments have been described with reference to the attached drawings. It should be understood by one of ordinary skill in the art that embodiments may be easily modified in other specific forms all without changing the technical spirit or the essential features of the disclosure. The disclosed embodiments are non-limiting examples of the disclosure and should be considered in a descriptive sense only and not for purposes of limitation.

What is claimed is:

1. A server device comprising:
a communication unit configured to communicate with a plurality of vehicles belonging to a pre-set group; and
a controller configured to control the communication unit,
wherein during group driving in which the plurality of vehicles travels to a first destination, when a first vehicle among the plurality of vehicles reaches the first destination, the controller is configured to:
receive, from the first vehicle, a response signal regarding whether to reset the first destination to a second destination, and
transmit the second destination to a second vehicle among the plurality of vehicles.

2. The server device of claim 1, wherein when the first vehicle is not a vehicle that sets the first destination of the group driving, the controller is configured to give an authority to reset the first destination to the first vehicle.

3. The server device of claim 1, wherein, when an acceptance signal to reset the first destination is received from the first vehicle, the controller is configured to control the communication unit to transmit the second destination and a resetting message to the second vehicle.

4. The server device of claim 1, wherein when an acceptance signal to reset the first destination is received, the controller is configured to control the communication unit to transmit to the second vehicle a route to the second destination.

5. The server device of claim 1, wherein when a rejection signal is received as the response signal regarding whether to reset the first destination from the first vehicle, the controller is configured to designate, as a new first vehicle, a vehicle reaching the first destination right after the first vehicle among the plurality of vehicles.

6. The server device of claim 1, further comprising a memory.

7. The server device of claim 6, wherein the controller is configured to:
control the communication unit to receive a resetting message selected from among a plurality of resetting messages stored in the memory from a driver of the first vehicle; and
transmit the selected resetting message to the second vehicle.

8. The server device of claim 6, wherein the controller is configured to control the memory to store the second destination in the memory.

9. A controlling method of a server device, the controlling method comprising:
during group driving in which a plurality of vehicles travels to a first destination, when a first vehicle among the plurality of vehicles reaches the first destination, receiving, from the first vehicle, a response signal regarding whether to reset the first destination to a second destination; and
transmitting the second destination to a second vehicle among the plurality of vehicles.

10. The controlling method of claim 9, further comprising, when the first vehicle is not a vehicle that sets the first destination of the group driving, giving an authority to reset the first destination to the first vehicle.

11. The controlling method of claim 9, wherein transmitting the second destination comprises: when an acceptance signal is received as the response signal regarding whether to reset the first destination from the first vehicle, transmitting the second destination and a resetting message to the second vehicle.

12. The controlling method of claim 9, further comprising: when an acceptance signal is received as the response signal regarding whether to reset the first destination, transmitting a route to the second destination to the second vehicle.

13. The controlling method of claim 9, further comprising: when a rejection signal is received from the first vehicle as the response signal regarding whether to reset the first destination, designating, as a new first vehicle, a vehicle reaching the first destination right after the first vehicle.

14. The controlling method of claim 11, wherein transmitting the resetting message to the second vehicle comprises:
receiving a resetting message selected among a plurality of resetting messages stored in a memory from a driver of the first vehicle and
transmitting the selected resetting message to the second vehicle.

15. The controlling method of claim 9, further comprising: controlling a memory to store the second destination in the memory.
